(19) United States
(12) Patent Application Publication
(10) Pub. No.: US 2012/0225211 A1
(43) Pub. Date: Sep. 6, 2012

(54) METHOD FOR PRODUCING LAMINATE FILM

(76) Inventor: Satoshi KUNIYASU, Minami-Ashigara-shi (JP)

(21) Appl. No.: 13/411,055

(22) Filed: Mar. 2, 2012

Related U.S. Application Data
(60) Provisional application No. 61/493,642, filed on Jun. 6, 2011.

(30) Foreign Application Priority Data
Mar. 3, 2011 (JP) 2011-046538

(51) Int. Cl. B05D 3/10

(52) U.S. Cl. 427/385.5

(57) ABSTRACT

In a method for producing a laminate film, a first coating fluid containing a first organic solvent in which particles having a first charge are dispersed and a second coating fluid containing a second organic solvent in which a binder having a second charge opposite to the first charge is dissolved are applied on one surface of a running support by wet-on-wet multilayer coating to form a second coating film and a first coating film, and the particles and the binder are gelated by neutralization between the charges to form a gelled layer. This method enables to prevent the first coating fluid and the second coating fluid from being mixed together.

### CROSS-REFERENCE TO RELATED APPLICATION

This non-provisional application claims priority under U.S.C. §119(e) of U.S. Provisional Application Ser. No. 61/493,642, filed on Jun. 6, 2011.

### BACKGROUND OF THE INVENTION

1. Field of the Invention

The present invention relates to a method of producing a laminate film and, in particular, to a method of producing a laminate film in which coating fluids containing organic solvents is applied in a multilayer manner to laminate functional layers on a support.

2. Description of the Related Art

In recent years, the screen of an image display device has become larger, and an optical film such as an anti-glare film or an anti-reflective film, for example, is arranged on a liquid-crystal display device. For example, the anti-glare film and the anti-reflective film prevent a decrease in contrast due to reflection of external light or an image in various image display devices, such as a liquid-crystal display device (LCD), a plasma display panel (PDP), an electro-luminescence display (ELD), and a cathode-ray tube display device (CRT).

The optical films described above are produced generally by providing a plurality of functional layers on a continuously-running long support. Coating fluids having different properties are applied onto the support and are dried one layer by one layer, and this process is repeated a plurality of times, thereby forming a plurality of functional layers on the support. However, in view of productivity, it is desirable to use multilayer coating in which a plurality of coating fluids are applied in one coating process.

### SUMMARY OF THE INVENTION

In multilayer coating, however, adjacent coating fluids disadvantageously mix with each other. Japanese Patent Application Laid-Open No. 2003-94826 discloses that, in order to prevent mixture of coating fluids, an intermediate layer with gelatin as a binder is provided between two adjacent layers as a set when water-based coating fluids are used. After simultaneous multilayer coating, cooling or the like is performed to gelate the binder. With this, mixture of the coating fluids can be suppressed.

However, when optical films such as anti-glare films and anti-reflective films are produced, an organic solvent is normally used. At this time, if gelatin, which is conventionally used in water-based coating fluids, is added to the organic solvent as a binder, it is not dissolved but disadvantageously coagulated. Excessive coagulation may degrade transparency of coating and cause a point-defect failure, which is a critical defect for optical films.

Japanese Patent Application Laid-Open No. 2003-62517 suggests that, in order to prevent mixture of coating fluids containing organic solvents, in a system for multilayer coating of the coating fluids containing the organic solvents, a coating fluid with a mixture ratio between a true solvent and another solvent being equal to or higher than gelation initiating ratio is used as a coating fluid which forms a lower layer. In a drying process after simultaneous multilayer coating, the concentration of the true solvent in the lower-layer coating fluid is decreased, and a gelled layer (gelated layer) is formed between the lower layer and the adjacent coating-liquid layer. With this gelled layer, mixture of the coating fluids is prevented.

However, in this scheme, gelation does not start unless drying proceeds. It takes time to sufficiently form a gelled layer immediately after coating, and therefore the upper layer and lower layer disadvantageously proceed to be mixed together.

The present invention has been made to solve the problems above, and has an object of providing a method of producing a laminate film, the method capable of suppressing mixture of an upper layer and a lower layer even when multilayer coating is performed with coating fluids containing organic solvents.

A method for producing a laminate film according to a first aspect of the present invention includes: a first step of preparing a first coating fluid containing a first organic solvent in which particles having a first charge are dispersed and a second coating fluid containing a second organic solvent in which a binder having a second charge opposite to the first charge is dissolved; and a second step of applying the second coating fluid and the first coating fluid on one surface of a running support by wet-on-wet multilayer coating to form a second coating film and a first coating film, and of gelating the particles and the binder by neutralization between the charges.

According to the first aspect, by wet-on-wet multilayer coating of the first coating fluid and the second coating fluid, the particles having the first charge and the binder having the second charge are gelated on a surface in contact between the first coating fluid and the second coating fluid by neutralization of the charges. With gelation, the viscosity of the surface in contact between the first coating fluid and the second coating fluid is increased, thereby preventing the coating fluids from being mixed together. Since gelation is initiated by the contact between the first coating fluid and the second coating fluid, it is possible to prevent the coating fluids from being mixed together from an initial stage after multilayer coating.

According to a second aspect of the present invention, in the first aspect, the second coating fluid preferably contains a polar organic solvent.

According to a third aspect of the present invention, in the first or second aspect, the particles having the first charge preferably each have a particle diameter equal to or larger than 5 nm and equal to or smaller than 100 nm.

According to a fourth aspect of the present invention, in any of the first to third aspects, the laminate film preferably has a haze equal to or lower than 1.0. While mixture of the first coating fluid and the second coating fluid is suppressed, the haze can also be suppressed low. Therefore, high-quality anti-reflective films with excellent transparency and sophistication can be rapidly produced.

According to a fifth aspect of the present invention, in any of the first to fourth aspects, preferably, the second coating fluid and the first coating fluid are applied to the support with an extrusion method, and the first coating fluid and the second coating fluid each have a wet film thickness equal to or smaller than 30 μm.

According to the method of producing a laminate film of the present invention, the coating fluids containing organic solvents can be prevented from being mixed together.

### BRIEF DESCRIPTION OF THE DRAWINGS

FIG. 1 is a sectional view schematically showing an anti-glare film;

FIG. 2 is a conceptual diagram showing multilayer coating;

FIG. 3 is a conceptual diagram showing prevention of interlayer mixture;

FIG. 4 shows a TEM (Transmission Electron Microscope) photograph of a laminate film in Test 1 in a sectional direction; and

FIG. 5 shows a TEM photograph of the laminate film in Test 2 in a sectional direction.

### DETAILED DESCRIPTION OF THE PREFERRED EMBODIMENTS

Preferred embodiments of the present invention are described below according to the attached drawings. While the present invention is described based on the preferred embodiments below, modifications can be made with various techniques without deviating from the scope of the present invention, and embodiments other than the present embodiments can also be used. Therefore, all modifications within the scope of the present invention are included in the claims.

Here, “(numerical value 1) to (numerical value 2)” means “equal to or larger than (numerical value 1) and equal to or smaller than (numerical value 2)”. Also, in the specification, “(metha)acrylate” means “at least either one of acrylate and methacrylate”. The same goes for “(metha)acrylic acid” and others.

<Structure>

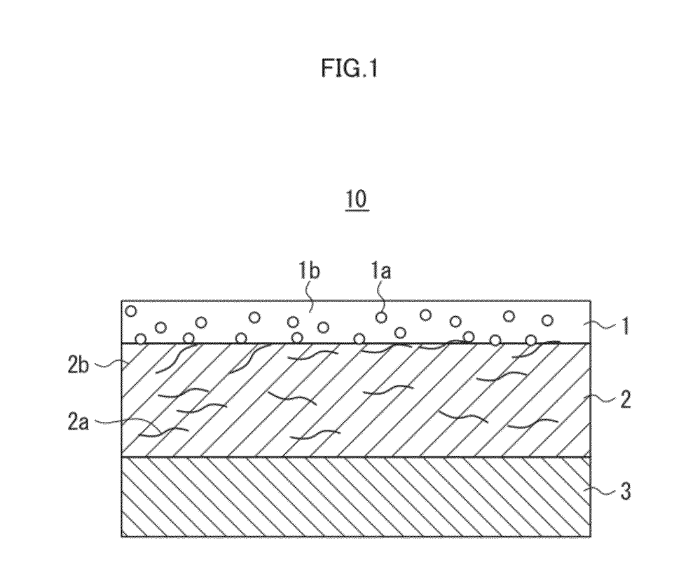

FIG. 1 is a sectional view of a basic structure of an anti-glare film, which is one type of laminate film. A laminate film 10 shown in FIG. 1 includes a support 3, a hard coat layer 2 provided on the support 3, and a low refractive index layer 1 provided on the hard coat layer 2. The low refractive index layer 1 includes a resin layer 1b and particles 1a dispersed in the resin layer 1b. The hard coat layer 2 includes a resin layer 2b and a binder 2a in the resin layer 2b.

As the particles 1a, silica, hollow silica, colloidal silica, tin oxide, antimony oxide, alumina oxide, or others can be used. Among these particles, silica, hollow silica, and colloidal silica assume a negative charge in a solvent. On the other hand, alumina oxide assumes a positive charge. It is also possible to use particles having a charge opposite to the charge of the particles alone assumed by causing a polymer or a surface active agent having the opposite charge to be absorbed onto each particle.

The binder 2a is charged with a second electric charge opposite to that of the particles 1a. As the binder 2a, a cationic polymer (oligomer) or an anionic polymer (oligomer) can be used. The cationic polymer (oligomer) is charged with a positive electric charge. Examples of the cationic polymer (oligomer) include an amine-salt-type polymer (oligomer) and an ammonium-salt-type polymer (oligomer). Examples of the amine-salt-type polymer (oligomer) include primary- to tertiary-amine-salt-type polymers (oligomers). Examples of the ammonium-salt-type polymer (oligomer) include secondary- to quaternary-ammonium-salt-type polymers (oligomers).

The anionic polymer (oligomer) is charged with a negative charge. Examples of the anionic polymer (oligomer) include carboxylate-type, phosphate-type, and sulfonate-type polymers, soap, alkylbenzene sulfonates (ABS and LAS), higher alcohol alkyl sulfate (AS), polyoxyethylene alkyl ether sulfate (AES), α-sulfofattyacid ester (α-SF), α-olefin sulfonate, monoalkyl phosphate ester (MAP), and alkane sulfonate (SAS).

In the present embodiment, with neutralization of charges between the particles 1a having a first charge and the binder 2a having a charge opposite to the first charge, a gelled layer is formed. As a result, in the production process, mixture of the hard coat layer 2 and the low refractive index layer 1 can be suppressed.

The laminate film 10 at least includes one hard coat layer 2 and one low refractive index layer 1 adjacent to the hard coat layer on the support 3. According to the object, one or more other functional layers can be provided.

As depicted in FIG. 1, when the hard coat layer 2 and the low refractive index layer 1 are laminated on the support 3, the resultant film can be suitably used as an anti-reflective film. By forming the low refractive index layer 1 having a film thickness of approximately ¼ of a light wavelength on the hard coat layer 2, surface reflection can be reduced by the principle of thin-film interference.

Examples of the layer structure in which the producing method according to the present embodiment are listed below.

support/hard coat layer/low refractive index layer

support/hard coat layer/antistatic layer

support/hard coat layer/antistatic and intermediate refractive index layer

support/hard coat layer/antistatic and high refractive index layer

support/hard coat layer/high refractive index layer/low refractive index layer

support/hard coat layer/intermediate refractive index layer/high refractive index layer/low refractive layer

<Support>

As a support, there is not particularly a limitation, and a transparent resin film, a transparent resin plate, a transparent resin sheet, transparent glass, and others can be used.

As a transparent resin film, a cellulose acylate film (for example, a cellulose triacetate film (with a refractive index of 1.48), a cellulose diacetate film, a cellulose acetate butyrate film, or a cellulose acetate propionate film), a polyethylene terephthalate film, a polyether sulfone film, a polyacrylic resin film, a polyurethane resin film, a polyester film, a polycarbonate film, a polysulfone film, a polyether film, a polymethylpentene film, a polyether ketone film, a (metha)acrylonitrile film, or others can be used.

Normally, a support having a thickness on the order of 25 μm to 1000 μm can be used. The thickness is preferably 25 μm to 250 μm, and more preferably 30 μm to 90 μm.

The width of the support for use can be any. However, in view of handling, yield, and productivity, a support having a width of 100 mm to 5000 mm is used. The width is preferably 800 mm to 3000 mm, and more preferably 1000 mm to 2000 mm.

The surface of the support is preferably smooth, and an average roughness Ra preferably has a value equal to or lower than 1 μm, more preferably 0.0001 μm to 0.5 μm, and further more preferably 0.001 μm to 0.1 μm.

(Cellulose Acylate Film)

Among these various films described above, the cellulose acylate film is preferable, which has high transparency, has optically less birefringence, is easy to produce, and is generally used as a protective film of a deflecting plate.

As for the cellulose acylate film, various improving technologies are known for the purpose of improving mechanical characteristics, transparency, flatness, and others. The technology described in Journal of Technical Disclosure No. 2001-1745 can be used as a known technology for the film of the present invention.

Among the cellulose acylate films, the cellulose triacetate film is particularly preferable, and a cellulose acetate with an acetylation degree of 59.0% to 61.5% is preferably used as a cellulose acylate film. The acetylation degree refers to an amount of coupled acetic acids per cellulose unit mass. The acetylation degree complies with measurement and calculation of an acetylation degree in ASTM: D-817-91 (a test method of cellulose acylate or the like).

The viscosity average decree of polymerization (DP) of cellulose acylate is preferably equal to or higher than 250, and further preferably equal to or higher than 290.

Also, cellulose acylate for use in the present invention preferably has a value of Mw/Mn (Mw is a mass-average molecular weight and Mn is a number-average molecular weight) by gel permeation chromatography of being close to 1.0, in other words, has a narrow molecular mass distribution. As specific examples of the value of Mw/Mn, 1.0 to 1.7 are preferable, 1.3 to 1.65 are more preferable, and 1.4 to 1.6 are most preferable.

In general, 2, 3, 6 hydroxyl groups of cellulose acylate film are not equally distributed by ⅓ of the entire degree of substitution but the degree of substitution of the sixth hydroxyl group tends to be small. In the present invention, the degree of substitution of the sixth hydroxyl group is preferably larger than those of the second and third ones.

With respect to the entire degree of substitution, 32% or more acyl group preferably substitutes for the sixth hydroxyl group. More preferably, 33% or more and, in particular, 34% or more, is preferable. Furthermore, the degree of substitution of the sixth acyl group of cellulose acylate is preferably equal to or higher than 0.88. Other than the acetyl group, a propionyl group, a valeroyl group, a butyloyl group, a benzoyl group, an acryloyl group, or the like, which is an acyl group with a carbon number equal to or larger than 3, may substitute for the sixth hydroxyl group. The degree of substitution of each position can be measured by NMR.

In the present invention, cellulose acetate obtained by the method described in Japanese Patent Application Laid-Open No. 11-5851, paragraphs 0043 to 0044, Example, Combined Example 1, paragraphs 0048 to 0049, Combined Example 2, paragraphs 0051 to 0052, and Combined Example 3 can be used as cellulose acylate.

(Polyethylene Terephthalate Film)

The polyethylene terephthalate film is also excellent in transparency, mechanical strength, flatness, chemical resistance, moisture resistance, furthermore at low cost, and therefore is preferably used.

To improve close contact strength (adhesion strength) between the transparent plastic film and a functional layer provided thereon, the transparent plastic film is preferably subjected to a high adhesion process. Example of an available PET film with an optical high adhesion layer include COSMOSHINE A4100 and A4300 manufactured by TOYOBO Co., Ltd.

<Hard Coat Layer>

To provide physical strength to the film, the hard coat layer 2 is provided on one surface of the support 3. The hard coat layer 2 has a refractive index in a range of 1.48 to 2.00 in view of optical functions. The hard coat layer 1 has a film thickness normally on the order of 0.5 μm to 50 μm, preferably 1 μm to 20 μm, further preferably 2 μm to 10 μm, and most preferably 3 μm to 7 μm, in view of providing sufficient durability and impact resistance to the film. Also, the hard coat layer preferably has a strength equal to or higher than H in a pencil hardness test standerdized by JIS K5400 (JIS: Japanese Industrial Standards), more preferably equal to or higher than 2H, and most preferably equal to or higher than 3H.

Furthermore, in a taper test complying with JIS K5400, a less amount of friction of a test piece before and after test is more preferable

(Coating Fluid for Forming Hard Coat Layer: Second Coating Fluid)

As a second organic solvent for use in the second coating fluid, various solvents can be used that is selected in view of for example, being capable of dissolving or dispersing each component, being prone to achieve a uniform surface in a coating process and a drying process, being capable of ensuring liquid preservability, having an appropriate saturation vapor pressure, and others.

Two or more types of solvents can be used as being mixed together. In particular, in view of a load of drying, it is preferable that a solvent with a boiling point at normal atmospheric pressure and ambient temperate being equal to or lower than 100° C. is used as a main component and that a small amount of a solvent with a boiling point being equal to or higher than 100° C. is contained for adjusting a drying speed.

Examples of the solvent with a boiling point lower than 100° C. include hydrocabons such as hexane (boiling point of 68.7° C.), heptane (98.4° C.), cyclohexane (80.7° C.), and benzene (80.1° C.); halogenated hydrocarbons such as dichloromethane (39.8° C.), chloroform (61.2° C.), carbon tetrachloride (76.8° C.), 1-2-dichloroethane (83.5° C.), and trichloroethylene (87.2° C.); ethers such as diethylether (34.6° C.), diisopropylether (68.5° C.), dipropylether (90.5° C.), and tetrahydrofuran (66° C.); esters such as ethyl formate (54.2° C.), methyl acetate (57.8° C.), ethyl acetate (77.1° C.), and isopropyl acetate (89° C.); ketones such as acetone (56.1° C.), methyl ethyl ketone (79.6° C.) and 2-butanone (79.6° C. which is equal to that of methyl ethyl ketone); alcoholes such as methanol (64.5° C.), ethanol (78.3° C.), 2-propanol (82.4° C.), and 1-propanol (97.2° C.); cyano compounds such as acetonitrile (81.6° C.) and propionitrile (97.4° C.); and carbon disulfide (46.2° C.). Among these, ketones and esters are preferable and, in particular, ketones are preferable. Among ketones, methyl ethyl ketone and 2-butanone are particularly preferable.

Examples of the solvent with a boiling point higher than 100° C. include octane (125.7° C.), toluene (110.6° C.), xylene (138° C.), tetrachloroethylene (121.2° C.), chlorobenzene (131.7° C.), dioxane (101.3° C.), dibutylether (142.4° C.), isobutyl acetate (118° C.), cyclohexanone (155.7° C.), 2-methyl-4-pentanone (115.9° C. which is equal to that of MIBK (methyl isobutyl keton)), 1-butanol (117.7° C.), N,N-dimethylformamide (153° C.), N,N-dimethylacetamide (166° C.), and dimethyl sulfoxide (189° C.). Preferably, cyclohexanone and 2-methyl-4-pentanone are used.

The hard coat layer 1 is preferably formed by a crosslinking reaction of an ionizing-radiation-curable compound or by a polymerizing reaction. For example, the hard coat layer can be formed by applying a coating composite containing a ionizing-radiation-curable polyfunctional monomer or polyfunctional oligomer onto a transparent support to cause a crosslinking reaction or a polymerizing reaction of the polyfunctional monomer or the polyfunctional oligomer.

Preferable examples of a functional group of the ionizing-radiation-curable polyfunctional monomer or polyfunctional oligomer are of light, electron beam, and radiation polymerization. Among these, a photopolymerization functional group is preferable.

Preferable examples of the photopolymerization functional group include unsaturated polymerization functional groups such as a (metha)acryloyl group, a vinyl group, a styryl group, and an aryl group. Among these, a (metha)acryloyl group is preferable.

Specific examples of the photopolymerized polyfunctional monomer with a photopolymerized functional group include (metha)acrylicdiesters of alkyleneglycol such as neopentylglycolacrylate, 1,6-hexanediol(metha)acrylate, and propyleneglycoldi(metha)acrylate; (metha)acrylicdiesters of polyoxyalkyleneglycol such as triethyleneglycoldi(metha)acrylate, dipropyleneglycoldi(metha)acrylate, polyethyleneglycoldi(metha)acrylate, and polypropyleneglycoldi(metha)acrylate; (metha)acrylicdiesters of polyalcohol such as pentaerythritoldi(metha)acrylate; and (metha)acrylicdiesters of an ethylene oxide or propylene oxide additive such as 2,2-bis{4-(acryloxy diethoxy)phenyl}propane and 2-2-bis{4-(acryloxy polypropoxy)pheny}propane.

Furthermore, epoxy(metha)acrylates, urethane(metha)acrylates, and polyester(metha)acrylates can be preferably used as a photopolymerized polyfunctional monomer.

Among these, esters made of polyalcohol and (metha)acrylic acid are preferable. A polyfunctional monomer having three or more (metha)acryloyl groups in one molecule is more preferable. Specifically, examples include trimethylolpropanetri(metha)acrylate, trimethylolethanetri(metha)acrylate, 1,2,4-cyclohexanetetra(metha)acrylate, pentaglyceroltriacrylate, pentaerythritoltetra(metha)acrylate, pentaerythritoltri(metha)acrylate, (di)pentaerythritoltriacrylate, (di)pentaerythritolpentaacrylate, (di)pentaerythritoltetra(metha)acrylate, (di)pentaerythritolhexa(metha)acrylate, tripentaerythritoltriacrylate, and tripentaerythritolhexatriacrylate. In the specification, “(metha)acrylate”, “(metha)acrylic acid”, and “(metha)acryloyl” represent “acrylate or methacrylate”, “acrylic acid or methacrylic acid”, and “acryloyl or methacryloyl”, respectively.

As monomer binders, in order to control a refractive index of each layer, monomers having different refractive indexes can be used. In particular, examples of a high-refractive-index monomer include bis(4-methacryloylthiophenyl)sulfide, vinylnaphthalene, vinylphenylsulfide, 4-methacryloxyphenyl-4′-methoxyphenylthioether, and others.

Also, for example, dendrimers described in Japanese Patent Application Laid-Open Nos. 2005-76005 and 2005-36105 and a norbornene-ring-containing monomer as described in Japanese Patent Application Laid-Open No. 2005-60425 can be used. Two or more types of polyfunctional monomers may be used together.

Polymerization of these monomers having ethylene unsaturated groups can be performed by ionizing radiation or heating, under the presence of an optical radical initiator or a heat radical initiator.

For polymerization reaction of photopolymerized polyfunctional monomers, a photopolymerization initiator is preferably used. As examples of the polymerization initiator, an optical radical polymerization initiator and an optical cationic polymerization initiator are preferable and, in particular, an optical radical polymerization initiator is preferable.

In using a charged binder, alcohol (a polar organic solvent) is preferably used together. Alcohol is used to dissolve the binder. As alcohol, methanol, ethanol, propyleneglycolmonomethylether, or others is preferably used.

<Low Refractive Index Layer>

To decrease the refractive index of the laminate film, a low refractive index layer is used.

The refractive index of the low refractive index layer is preferably 1.20 to 1.46, more preferably 1.25 to 1.46 and, in particular, preferably 1.30 to 1.46.

The thickness of the low refractive index layer is preferably 50 nm to 200 nm, and more preferably 70 nm to 100 nm. Haze of the low refractive index layer is preferably equal to or lower than 3%, more preferably equal to or lower than 2%, and most preferably equal to or lower than 1%. A specific strength of the low refractive index layer is preferably equal to or higher than H in a pencil hardness test with a load of 500 g, more preferably equal to or higher than 2H, and most preferably equal to or higher than 3H.

Also, to improve antifouling capabilities of an optical film, an angle contact with respect to surface water is preferably equal to or larger than 90 degrees. It is more preferably equal to or larger than 95 degrees, and is particularly preferably equal to or larger than 100 degrees.

The curable composite is preferably formed to contain (A) the fluorine-containing polymer, (B) particles, and (C) an organosilane compound.

As a low refractive index layer, a binder is used for dispersing and fixing the fine particles of the present invention. As a binder, the binder described in the hard coat layer described above can be used, and a fluorine-containing polymer with a low refractive index of the binder or a fluorine-containing sol-gel material is preferably used. As a fluorine-containing polymer or a fluorine-containing sol-gel, a material that is crosslinked by heat or ionizing radiation, has a coefficient of kinetic friction of the surface of the low refractive index layer of 0.03 to 0.30, and has an angle of contact with water of 85° to 120° is preferable.

(Coating Fluid for Forming Low Refractive Index Layer: First Coating Fluid)

As a first organic solvent for use in a first coating fluid, the second organic solvent for use in the second coating fluid can be used.

In the present invention, among polymer binders, a fluorine-containing copolymer compound (a fluorine-containing polymer binder) can be preferably used particularly for the low refractive index layer.

Examples of a fluorine-containing vinyl monomer include fluoroolefins (for example, fluoroethylene, vinylidene fluoride, tetrafluoroethylene, hexafluoropropylene, and others), partially-fluorinated or perfluoro alkylester derivatives of (metha)acrylic acid (for example, Biscoat 6FM (product name, manufactured by Osaka Organic Chemical Industry Ltd.) and R-2020 (product name, manufactured by Daikin Industries, Ltd, and others), and partially-fluorinated or perfluoro vinylethers. However, perfluoroolefins are preferable, and hexafluoropropylene is particularly preferable in view of points, such as refractive index, solubility, transparency, availability and others. If the composition ratio of the fluorine-containing vinyl monomer is increased, the refractive index can be decreased, but coat strength is decreased. In the present invention, the fluorine-containing vinyl monomer is preferably introduced so that the fluorine content ratio of the copolymer is 20 mass percent to 60 mass percent. More preferably, the ratio is 25 mass percent to 55 mass percent. Particularly preferably, the ratio is 30 mass percent to 50 mass percent.

Examples of a constitutional unit for providing crosslink reactivity include the following units (A), (B), and (C):

(A) A constitutional unit obtained by polymerizing a monomer having a self-crosslink functional group in advance in molecules, such as glycidyl(metha)acrylate and glycidylvinylether;

(B) A constitutional unit obtained by polymerizing a monomer having a carboxyl group, an amino group, a sulfo group, or others (for example, (metha)acrylic acid, methylol(metha)acrylate, hydroxyalkyl(metha)acrylate, allyl acrylate, hydroxyethylvinylether, hydroxybutylvinylether, maleic acid, crotonic acid, and others); and

(C) A constitutional unit obtained by causing a compound having a crosslink functional group other than the group reacting with the functional groups in (A) and (B) described above in molecules to react with the constitutional units in (A) and (B) (for example, a constitutional unit that can be composed by a scheme of acting acrylic chloride with respect to a hydroxyl group).

The constitutional unit (C) above preferably has a photopolymerized group as a crosslink functional group. Here, examples of the photopolymerized group include a (metha)acryloyl group, an alkenyl group, a cinnamoyl group, a cinnamylidene acetyl group, a benzal acetophenone group, a styryl pyridine group, an α-phenyl maleimide group, a phenyl azide group, a sulfonyl azide group, a carbonyl axide group, a diazo group, an o-quinonediaxide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, and an azadioxabicyclo group. Of these, not only one but two or more can be used. Among these, a (metha)acryloyl group and a cinnamoyl group are preferable, and a (metha)acryloyl group is particularly preferable.

Specific examples of a method of preparing a photopolymerized-functional-group-containing copolymer include the following methods, although not restrictive:

a. A method of causing a (metha)acrylic chloride to react with a crosslinking-functional-group-containing copolymer containing a hydroxyl group for esterification;
b. A method of causing a (metha)acrylic ester containing an isocyanate group to react with a crosslinking-functional-group-containing copolymer containing a hydroxyl group for urethanification;
c. A method of causing a (metha)acrylic acid to react with a crosslinking-functional-group-containing copolymer containing an epoxy group for esterification; and
d. A method of causing a (metha)acrylic ester containing an epoxy group to react with a crosslinking-functional-group-containing copolymer containing a carboxyl group for esterification.

Note that the amount of introduction of the photopolymerized group can be adjusted in any manner, a carboxyl group, a predetermined amount of a hydroxyl group, or others is preferably left, in view of stability in coating surface, decrease in failure of the surface at the time of coexistence of inorganic particles, improvement in film strength, and others.

In the copolymer that is useful in the present invention, other than a repeating unit derived from the fluorine-containing vinyl monomer and a repeating unit having a (metha)acryloyl group at a side chain, another vinyl monomer can be copolymerized as appropriate in view of various points, such as close contact with a base, Tg (Tg indicates glass transition temperature) of the polymer (which contributes to coating hardness), solubility in a solvent, transparency, slidability, dust-proofing, antifouling, and others. A plurality of these vinyl monomers may be combined according to the purpose, and are preferably introduced in a range of 0 mol % to 65 mol % in the copolymer in total, more preferably in a range of 0 mol % to 40 mol %, and particularly preferably in a range of 0 mol % to 30 mol %.

The vinyl monomer unit usable together is not particularly restrictive, and examples include olefins (such as ethylene, propylene, isoprene, vinyl chloride, and vinylidene chloride), acrylic esters (methyl acrylate, ethyl acrylate, acrylic 2-ethylhexyl, and acrlyic 2-hydroxyethyl), methacrylic esters (such as methacrylic methyl, methacrylic ethyl, methacrylic butyl, and methacrylic 2-hydroxyethyl), styrene derivatives (such as styrene, p-hydroxymethylstyrene, and p-methoxystyrene), vinyl ethers (such as methylvinylether, ethylvinylether, cyclohexylvinylether, hydroxyethervinylether, and hydroxybutylvinylether), vinyl esters (such as vinyl acetate, vinyl propionate, and vinyl cinnamate), unsaturated carboxylic acids (such as acrylic acid, methacrylic acid, crotonic acid, maleic acid, and itaconic acid), acrylic amides (such as N,N-dimethylacrylamide, N-tert-butylacrylamide, and N-cyclohexylacrylamide), methacrylamids (N,N-dimethylmethacrylamide), and acrylonitrile.

A fluorine-containing polymer particularly useful in the present invention is a random copolymer of perfluoroolefin and vinylether or vinylester and, in particular, preferably has a group that can make a crosslinking reaction alone (such as a radical reactive group such as a (metha)acryloyl group and a ring-opening polymerized group such as an epoxy group and an oxetanyl group). These crosslinking-reactive-group-containing polymerizing units preferably occupy 5 mol % to 70 mol % of the total polymerizing units of the polymer and, in particularly, 30 mol % to 60 mol %. Examples of preferable polymers include those described in Japanese Patent Application Laid-Open Nos. 2002-243907, 2002-372601, 2003-26732, 2003-222702, 2003-294911, 2003-329804, 2004-4444, and 2004-45462.

In order to provide antifouling, a polysiloxane structure is preferably introduced to the fluorine-containing polymer of the present invention. Although a method of introducing a polysiloxane structure is not restrictive, it is preferable to use a method of introducing a polysiloxane block copolymer component by using a sliconemacroazo initiator as described in each of Japanese Patent Application Laid-Open Nos. 6-93100, 11-189621, 11-228631, and 2000-313709 or a method of introducing a polysiloxane graft copolymer component by using a silicone macromer as described in Japanese Patent Application Laid-Open Nos. 2-251555 and 2-308806. Examples of particularly preferable compounds include polymers in first, second, and third examples in Japanese Patent Application Laid-Open No. 11-189621 or copolymers A-2 and A-3 in Japanese Patent Application Laid-Open No. 2-251555. These polysiloxane components have 0.5 mass percent to 10 mass percent in a polymer and, particularly preferably 1 mass percent to 5 mass percent.

Regarding the molecular weight of the polymer usable in the present invention, the mass average molecular weight is preferably equal to or larger than 5000, more preferably 10000 to 500000, most preferably 15000 to 200000. By using polymers of different average molecular weights, the coating surface condition and mar-proofing can be improved.

For the polymer described above, a curing agent having a polymerized unsaturated group as appropriate can be used together, as described in Japanese Patent Application Laid-Open Nos. 10-25388 and 2000-17028. Also, as described in Japanese Patent Application Laid-Open No. 2002-145952, using a compound having a polyfunctional polymerized unsaturated group together is also preferable. Examples of the compound having a polyfunctional polymerized unsaturated group include polyfunctional monomers described regarding the hard coat layer. These compounds are preferable because they have a large combined-use effect on improvement in mar-proofing particularly when a compound having a polymerized unsaturated group is used for a polymer body.

The first coating fluid preferably contain at least one type of component of a hydrolysate of an organosilane compound and/or a partial condensate of an organosilane compound, that is, a so-called sol component (hereinafter also referred to as such), in view of mar-proofing.

In particular, in an anti-reflective film, in order to achieve both anti-reflective and mar-proof capabilities, the low refractive index layer and the functional layer both preferably contain sol components. This sol components condense into a cured material in drying and heating processes after the coating fluid is applied, and becomes part of the binder of the layers. Also, the cured material has a polymerized unsaturated bond, a binder having a three-dimensional structure is formed by radiation of active light.

A preferable organosilane compound is represented by the following General Formula 1:

(R¹)ₘ—Si(X)₄₋ₘ General Formula 1:

In General Formula I above, R¹ represents a substituted or unsubstituted alkyl group or a substituted or unsubstituted aryl group. As an alkyl group, an alkyl group with a carbon number of 1 to 30 is preferable. More preferably, the carbon number is 1 to 16. Particularly preferably, the carbon number is 1 to 6. Specific examples of the alkyl group includes methyl, ethyl, propyl, isopropyl, hexyl, decyl, and hexadecyl. Examples of the aryl group include phenyl and naphtyl, and a phenyl group is preferable.

X represents a hydroxyl group or a group capable of hydrolysis, and the examples include an alkoxy group (an alkoxy group having a carbon number of 1 to 5 is preferable, such as a methoxy group, and an ethoxy group), a halogen atom (such as Cl, Br, and I), and R²COO (preferably, R² is a hydrogen atom or an alkyl group having a carbon number of 1 to 6, such as CH₃COO and C₂H₅COO), preferably an alkoxy group and, particularly preferably a methoxy group or an ethoxy group. m represents an integer of 1 to 3, preferable 1 to 2.

As the particles, silica, hollow silica, colloidal silica, tin oxide, antimony oxide, alumina oxide, or others can be used. The particles assume a positive or negative charge in the solvent. A method of producing hollow silica is described in, for example, Japanese Patent Application Laid-Open Nos. 2001-233611 and 2002-79616. Particles particularly having a hollow inside a shell and with the shell fine pore closed are particularly preferable. Note that these hollow silica particles have a refractive index, which can be calculated by the method described in Japanese Patent Application Laid-Open No. 2002-79616.

For example, silica, hollow silica, and colloidal silica assume a negative charge in the solvent.

The particles preferably have a particle diameter equal to or larger than 5 nm and equal to or smaller than 100 nm and, more preferably have a particle diameter equal to or smaller than 50 nm. As the particle diameter is larger, the particles are less prone to diffuse to an adjacent layer. On the other hand, if the particle diameter is larger than 100 nm, the head of each particle may protrude from the film surface and come off Also, asperities (convexo-concaves) are formed on the film surface to cause the film to be prone to be whitened, and therefore the film may become unsuitable for a necessary purpose due to low haze.

### <Method of Producing Laminate Film>

A first coating fluid containing a first organic solvent with particles having a first charge dispersed therein is prepared. A second coating fluid containing a second organic solvent with a binder having a second charge dissolved therein is prepared.

As a combination of the particles and the binder, a combination of particles assuming a negative charge and a binder made of a cationic polymer (oligomer) or a combination of particles assuming a positive charge and a binder made of an anionic polymer (oligomer) can be used.

Also, for efficient gelation, the concentration of the coating fluid is preferably high. For example, preferably, the first coating fluid contains 98 weight percent or lower of the first organic solvent, and the second coating fluid contains 98 weight percent or lower of the second organic solvent.

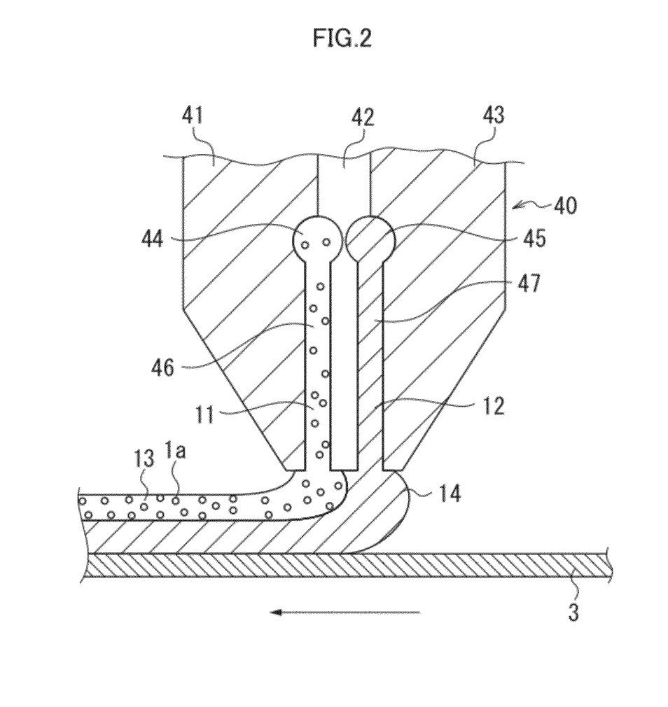

FIG. 2 is a conceptual diagram showing the state in which the first coating fluid and the second coating fluid are applied onto the support in a multilayer manner by an extrusion-type die coater. As shown in FIG. 2, a first coating fluid 11 and the second coating fluid 12 are supplied from an extrusion-type die coater 40 toward a running support 3. The die coater 40 is configured of three die blocks 41, 42, and 43. By combining these three die blocks 41, 42, and 43, two pockets 44 and 45 and slots 46 and 47 extending from the pockets 44 and 45 to the tip of the die coater 40 are formed. In this manner, with the die coater 40 being configured as having a multiblock structure, the production accuracy of the die coater 40 is increased, and post treatments such as cleaning can be easily performed.

The second coating fluid 12 is discharged from the slot 47 to be supplied onto the support 3. The first coating fluid 11 is discharged from the slot 46 to be supplied onto the second coating fluid 12. With this, the first coating fluid 11 and the second coating fluid 12 are applied onto the support 3 in a multilayer manner. With this, a second coating 14 and a first coating 13 are formed on the support 3 by wet-on-wet multilayer coating.

In the first coating fluid 11, the particles 1a having the first charge are dispersed.

In the second coating fluid 12, the binder having the second charge is dissolved.

FIG. 2 shows multilayer coating by the extrusion-type die coater 40. However, this is not meant to be restrictive, and a slide-type die coater can also be used.

As a result of diligent studies, it has been found that an extrusion-type die coater is suitable when coating is performed to form a thin film in which each layer has a wet film thickness of 30 μm or smaller.

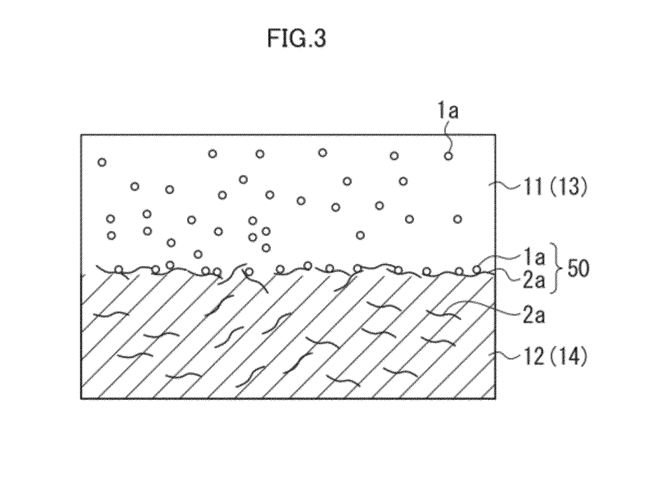

FIG. 3 shows the state in which the first coating fluid 11 and the second coating fluid 12 are applied in a multilayer manner. The particles 1a assuming the first charge are dispersed in the first coating fluid 11. On the other hand, a binder 2a assuming the second charge opposite to the first charge is dispersed in the second coating fluid 12. At an interface between the first coating fluid 11 and the second coating fluid 12, gelation occurs due to neutralization of charges between the particles 1a assuming the first charge and the binder 2a assuming the second charge. With the particles 1a and the binder 2a, a gelled layer 50 is formed. Here, gelation means a state in which the particles 1a and the binder 2a form a crosslinked structure. With gelation, viscosity of the contact surface between the first coating fluid 11 and the second coating fluid 12 is increased. With this, the first coating fluid 11 (the first coating 13) and the second coating fluid 12 (the second coating 14) can be prevented from being mixed together.

After multilayer coating, the first coating fluid 11 and the second coating fluid 12 are dried while the support 3 is driven to run. By being dried, the first organic solvent contained in the first coating fluid 11 and the second organic solvent contained in the second coating fluid 12 are evaporated.

After being dried, the first coating fluid 11 and the second coating fluid 12 are cured, and then the support 3 is wound up into a roll shape.

### EXAMPLES

The present invention is described in more detail below with reference to examples and comparative examples of the present invention. However, these are not meant to be restrictive.

<Support>

Cellulose triacetate film (TAC-TD80U, manufactured by FUJIFILM Corporation, a thickness of 80 μm)<

Preparation of First Coating Fluid>

A fluid prepared by using the following method was used as a first coating fluid (a coating fluid 1).

To 500 parts of hollow silica-particle fine particle sol (isopropyl alcohol silica sol, CS60-IPA manufactured by Catalysts & Chemicals Industries Co., Ltd., an average particle diameter of 60 nm, a shell thickness of 10 nm, a silica concentration of 20%, and a refractive index of silica particles of 1.31), 20 parts of acryloyloxypropyltrimethoxysilane and 1.5 parts of isopropoxyaluminumethylacetate were added and mixed, and then 9 parts of ion-exchanged water was added. After reaction at 60° C. for eight hours, cooling was performed to ambient temperature, and 1.8 parts of acetylacetone was added, thereby obtaining a dispersion fluid. Then, while cyclohexanone is added so that the content of silica is approximately constant, solvent replacement was performed by reduced-pressure distillation at a pressure of 30 Torr. Finally, the concentration was adjusted, thereby obtaining a dispersion fluid having a solid concentration of 18.2%. An IPA remaining amount in the obtained hollow-silica-particle dispersion fluid was analyzed by gas chromatography to be found as 0.5%.

Composition of First Coating Fluid

| | |
|---|---|
| DPHA | 1.0 parts by mass |
| P-1 | 1.6 parts by mass |
| Hollow-silica-particles-dispersion fluid (18.2%) | 28.7 parts by mass |
| IRGACURE 907 | 0.3 parts by mass |
| MEK (methyl ethyl ketone) | 168.4 parts by mass |

Compounds for use are listed below.

DPHA: mixture of dipentaerythritolpentaacrylate and dipentaerythritolhexaacrylate [manufactured by Nippon Kayaku Co., Ltd.]

“P-1”: fluorine-containing copolymer P-3 described in Japanese Patent Application Laid-Open No. 2004-45462 (weight-average molecular weight of approximately 50000)

IRGACURE 907: polymerization initiator [manufactured by BASF JAPAN Ltd.] (IRGACURE is a trademark)<

Preparation of Second Coating Fluid>

A fluid prepared by the following method was used as a second coating fluid (a coating fluid 2).

Composition of Second Coating Fluid

| | |
|---|---|
| PET-30 | 20.0 parts by mass |
| DPHA | 15.0 parts by mass |
| 1SX-1055 | 10.0 parts by mass |
| IRGACURE 127 | 2.0 parts by mass |
| Methyl isobutyl ketone | 30.0 parts by mass |
| Methyl ethyl ketone | 13.0 parts by mass |
| Methanol | 10.0 parts by mass |

Compounds for use are listed below.

PET-30: mixture of pentaerythritoltriacrylate and pentaerythritoltetraacrylate [manufactured by Nippon Kayaku Co., Ltd.]

DPHA: mixture of dipentaerythritolpentaacrylate and dipentaerythritolhexaacrylate [manufactured by Nippon Kayaku Co., Ltd.]

1SX-1055: cationic acrylic resin [manufactured by Taisei Fine Chemical Co., Ltd.]

IRGACURE 127: polymerization initiator [manufactured by BASF JAPAN Ltd.]

<Preparation of Third Coating Fluid>

A fluid prepared by the following method was used as a third coating fluid (a coating fluid 3).

Composition of Third Coating fluid

| | |
|---|---|
| PET-30 | 20.0 parts by mass |
| DPHA | 15.0 parts by mass |
| IRGACURE 127 | 2.0 parts by mass |
| Methyl isobutyl ketone | 30.0 parts by mass |
| Methyl ethyl ketone | 13.0 parts by mass |

Compounds for use are listed below.

PET-30: mixture of pentaerythritoltriacrylate and pentaerythritoltetraacrylate [manufactured by Nippon Kayaku Co., Ltd.]

DPHA: mixture of dipentaerythritolpentaacrylate and dipentaerythritolhexaacrylate [manufactured by Nippon Kayaku Co., Ltd.]

1SX-1055: cationic acrylic resin [manufactured by Taisei Fine Chemical Co., Ltd.]

IRGACURE 127: polymerization initiator [manufactured by BASF JAPAN Ltd.]

Note that in the comparative example, the third coating fluid was used in place of the second coating fluid of the example.

<Coating Conditions>

On a support, the coating fluid 1 and the coating fluid 2 and the coating fluid 1 and the coating fluid 3 were applied in a multilayer manner by using an extrusion-type die coder. Coating was made under a condition of a conveyance speed of 30 m/minute, drying was performed at 30° C. for 15 seconds and at 60° C. for 30 seconds and then, furthermore, ultraviolet rays with an amount of radiation of 90 mJ/cm² was applied by using an air-cooled metal halide lamp (manufactured by Eye Graphics Co., Ltd.) of 160 W/cm under a nitrogen purge to cure the coat layer.

<Evaluation of Laminate Film>

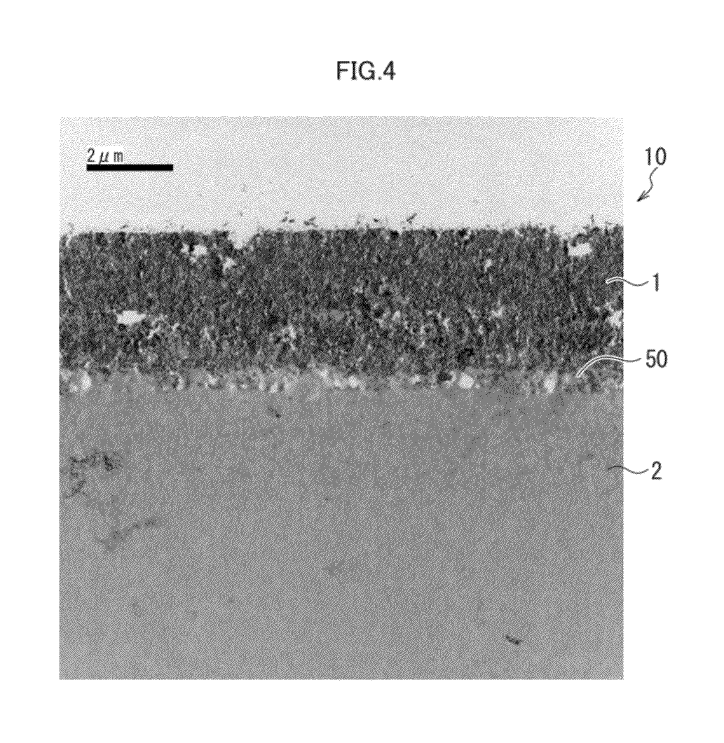

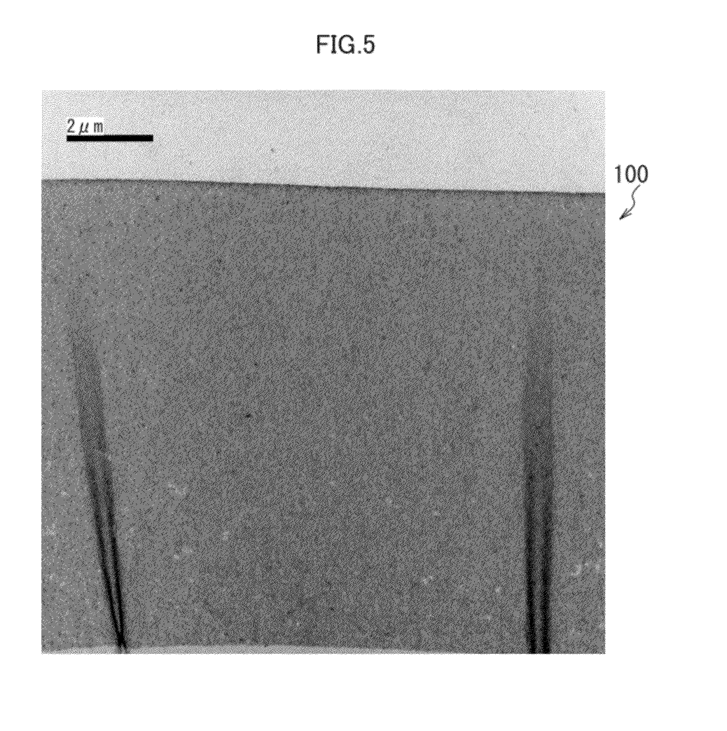

FIG. 4 shows a TEM photograph of the laminate film 10 in Test 1 in a sectional direction. FIG. 5 shows a TEM photograph of the laminate film 100 in Test 2 in a sectional direction. According to FIG. 4, in the laminate film 10 in Test 1, the anti-reflective layer 1 and the hard coat layer 2 were separated from each other by the gelled layer 50, and a mixture of the coating fluid 1 and the coating fluid 2 was prevented.

On the other hand, according to FIG. 5, in the laminate film 100 in Test 2, the anti-reflective layer and the hard coat layer were not separated, and a mixture occurred between the coating fluid 1 and the coating fluid 3.

What is claimed is:

1. A method for producing a laminate film comprising:
a first step of preparing a first coating fluid containing a first organic solvent in which particles having a first charge are dispersed and a second coating fluid containing a second organic solvent in which a binder having a second charge opposite to the first charge is dissolved; and
a second step of applying the second coating fluid and the first coating fluid on one surface of a running support by wet-on-wet multilayer coating to form a second coating film and a first coating film, and of gelating the particles and the binder by neutralization between the charges.

2. The method for producing a laminate film according to claim 1, wherein the second coating fluid contains a polar organic solvent.

3. The method for producing a laminate film according to claim 1, wherein the particles having the first charge each have a particle diameter equal to or larger than 5 nm and equal to or smaller than 100 nm.

4. The method for producing a laminate film according to claim 1, wherein the laminate film has a haze equal to or lower than 1.0.

5. The method for producing a laminate film comprising according to claim 1, wherein the second coating fluid and the first coating fluid are applied to the support with an extrusion method, and the first coating fluid and the second coating fluid each have a wet film thickness equal to or smaller than 30 μm.
